(19) United States
(12) Patent Application Publication
(10) Pub. No.: US 2008/0049049 A1
(43) Pub. Date: Feb. 28, 2008

(54) DISPLAY APPARATUS, AND CONTROL METHOD THEREOF

(75) Inventors: Ji-yong PARK, Suwon-si (KR); Sang-kyun IM, Seoul (KR); Myung-jin CHO, Suwon-si (KR); Alexander ANUFRIENKO, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/763,058

(22) Filed: Jun. 14, 2007

(30) Foreign Application Priority Data
Aug. 22, 2006 (KR) 10-2006-0079439

(51) Int. Cl. H04N 5/335

(52) U.S. Cl. 345/690

(57) ABSTRACT

A control method and a display apparatus are provided. The control method includes dividing a display part into sections; detecting output luminance levels which correspond to grayscale levels of an input video signal on a section by section basis; converting the output luminance levels by calculating calibration coefficients on a section by section basis and applying the calculated calibration coefficients to the respective detected output luminance levels to control respective maximum luminance levels of the detected output luminance levels to be a permitted luminance level; and setting up a calibration table based on the respective converted luminance levels and a reference luminance level. The display apparatus includes a display part which comprises a plurality of sections; a signal processing part; and a controller which detects output luminance levels on a section by section basis, converts the output luminance levels, and sets up a calibration table.

### CROSS-REFERENCE TO RELATED APPLICATIONS

This application claims priority from Korean Patent Application No. 10-2006-0079439 filed on Aug. 22, 2006, in the Korean Intellectual Property Office, the entire disclosure of which is incorporated herein by reference.

### BACKGROUND OF THE INVENTION

1. Field of the Invention

Methods and apparatuses consistent with the present invention relate to a display apparatus, and a control method thereof, and more particularly, to a display apparatus, and a control method thereof, which can uniformly output a luminance level of a received video signal.

2. Description of the Related Art

Generally, if a video signal is received, a display apparatus processes the video signal to provide the processed video signal to a display module unit, and the display module unit displays a corresponding video on a display part. At this time, a luminance deviation may occur between different areas displayed on the display part due to electrical, physical, and/or optical properties of the display apparatus. The luminance deviation may be as great as 20% at a maximum. If a luminance deviation occurs, although two areas have a same grayscale level, the two areas may have a luminance level different from each other.

Accordingly, a video signal is calibrated to uniformly output a corresponding luminance level. Particularly, for example, a medical display apparatus calibrates a video signal to control a corresponding luminance level to meet the Digital Imaging and Communications in Medicine (DICOM) curve. The DICOM curve denotes a function of a luminance level outputted according to a grayscale level of a concerned video signal.

However, a related art calibration process to control a corresponding luminance level to meet the DICOM curve is performed by measuring a luminance level of only a specific area (for example, a center area or a border area) of a display part. Accordingly, a discrepancy between the video signal and the DICOM curve is generated in another area that is calibrated without measuring a corresponding luminance level, and thus the corresponding luminance level may not be uniformly output by area.

Thus, methods of performing a calibration process to uniformly output a luminance level of a received video signal have been disclosed. For example, one related art method is to divide a display part into a plurality of sections and to calculate and use a calibration coefficient by section. Here, to use the calibration coefficient denotes using each difference between luminance levels outputted by section, to thereby calibrate a corresponding video signal without generating the respective differences between luminance levels outputted by section. However, if such a calibration coefficient is used, the whole luminance levels are changed to meet a reference luminance level. Accordingly, if a corresponding calibration process is performed with a corresponding calibration coefficient, the calibration process cannot meet the DICOM curve.

Another related art method is to divide the display part into a plurality of sections in the same way as the above-described method and to calibrate a corresponding video signal based on a section having a minimum luminance level among the respective luminance levels outputted by section. However, if a corresponding calibration process is performed based on the section having the minimum luminance level, the contrast ratio between a maximum luminance level and a minimum luminance level over the whole sections will be reduced. Accordingly, a loss of the contrast ratio will be generated.

### SUMMARY OF THE INVENTION

Accordingly, the present invention provides a display apparatus, and a control method thereof, which can uniformly output a luminance level of a received video signal without a loss of a corresponding contrast ratio.

Further, the present invention provides a display apparatus, and a control method thereof, which calibrates the received video signal to control the luminance level to meet the DICOM curve.

Additional aspects of the present invention will be set forth in part in the description which follows and, in part, will be obvious from the description, or may be learned by practice of the present invention.

According to an aspect of the present invention, there is provided a control method of a display apparatus including a display part to display a video, the control method comprising dividing the display part into a plurality of sections and detecting a luminance level outputted corresponding to a grayscale level of an inputted video signal by section; converting the luminance level by calculating a calibration coefficient and applying the calculated calibration coefficient to the respective detected luminance levels to control respective maximum luminance levels of the detected luminance levels to be a luminance level capable of being outputted on the display part at a maximum; and setting up a calibration table based on a comparison of the respective converted luminance levels with a reference luminance level.

The control method may further comprise calibrating the grayscale level of the inputted video signal to output the respective luminance levels of the inputted video signal based on the set calibration table.

The detecting the luminance levels outputted by section may comprise combining at least two sections which have a detected luminance level difference between each other within a threshold range.

The control method may further comprise recalibrating the luminance levels by section to prevent a difference between luminance levels corresponding to a section and its neighbor section, respectively, from being larger than a threshold range.

According to another aspect of the present invention, there is provided a display apparatus comprising a display part which includes a plurality of divided sections; a signal processing part which processes a received video signal; and a controller which detects a luminance level outputted corresponding to an grayscale level of the received video signal by section, converts the luminance level by calculating a calibration coefficient and applying the calculated calibration coefficient to the respective detected luminance levels to control respective maximum luminance levels of the detected luminance levels to be a luminance level capable of being displayed on the display part at a maximum, and sets up a calibration table by comparing the respective converted luminance levels with a reference luminance level.

The controller may control the signal processing part to output the luminance level of the video signal based on the set calibration table.

The controller may control the signal processing part to calibrate the grayscale level of the video signal.

The controller may combine at least two sections that have a detected luminance level difference between each other within a threshold range.

The controller may recalibrate the luminance levels by section to prevent a difference between luminance levels corresponding to a section and its neighbor section, respectively, from being larger than a threshold range.

The display apparatus may comprise a medical display apparatus.

### BRIEF DESCRIPTION OF THE DRAWINGS

The above and other aspects of the present invention will become apparent and more readily appreciated from the following description of exemplary embodiments of the present invention, taken in conjunction with the accompanying drawings of which:

FIG. 1 is a control block view illustrating a display apparatus according to an exemplary embodiment of the present invention;

FIG. 2 illustrates an outputted luminance level detected by section in the display apparatus according to an exemplary embodiment of the present invention;

FIG. 3 illustrates a luminance level and a reference luminance level by section of the display apparatus according to an exemplary embodiment in the present invention; and

FIG. 4 is a flowchart illustrating a control operation of the display apparatus according to an exemplary embodiment of the present invention.

### DETAILED DESCRIPTION OF EXEMPLARY EMBODIMENTS OF THE PRESENT INVENTION

Reference will now be made in detail to exemplary embodiments of the present invention, examples of which are illustrated in the accompanying drawings, wherein like reference numerals refer to like elements throughout.

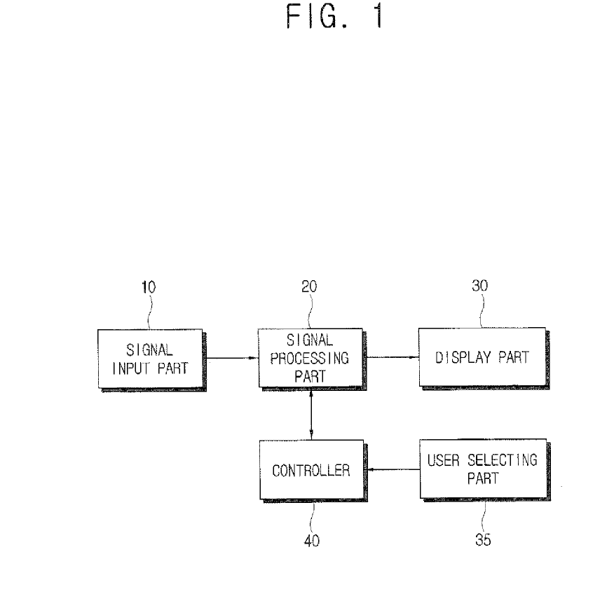

Hereinafter, an exemplary embodiment of the present invention will be described with reference to FIG. 1.

FIG. 1 is a control block diagram illustrating a display apparatus according to an exemplary embodiment of the present invention. As illustrated, the display apparatus includes a signal input part 10, a signal processing part 20, a display part 30, and a controller 40. The display part 30 may be divided into multiple sections (for example, a first section, a second section, and a third section) as described in more detail below.

The signal input part 10 receives a video signal and a synchronizing signal. Herein, the signal input part 10 includes a tuner (not shown) to receive a broadcast signal, and an external connecting port (not shown) to receive the video signal from an external apparatus.

It is advantageous if the external connecting port (not shown) includes various types of connectors capable of receiving various formats of video signals. For example, the signal input part 10 may include at least one connector among a D-Sub connector, a Composite Video Baseband Signal (CVBS) connector, an S-video connector, and a component connector, to receive a video signal.

The signal processing part 20, according to control of a controller 40 to be described below, processes the video signal inputted from the signal input part 10, and provides the processed video signal to the display part 30 to display a corresponding video thereon. As one example of such processing, the signal processing part 20 changes a grayscale level according to control of the controller 40.

Further, the signal processing part 20 may perform various additional functions corresponding to respective formats of the received video signals. For example, the additional functions may include an A/D converting function to convert video signals inputted in various formats into digital video signals in one of the various formats; a digital decoding function; a scaling function to adjust a vertical frequency, a resolution, and/or a screen aspect ratio, etc. to meet a display standard of the display part 30 after receiving a digital video signal; and a format converting function.

The display part 30 displays a corresponding video thereon. The display part 30, which may be divided into a plurality of sections, includes a Liquid Crystal Display (LCD) panel, a Plasma Display Panel (PDP), or the like.

The controller 40, which may include a Central Processing Unit (CPU), a microcomputer, or the like, measures a luminance level outputted to the display part 30 according to a grayscale level of the inputted video signal, and sets up a calibration table.

In particular, the controller 40 divides the display part 30 into a plurality of sections, and detects a luminance level outputted corresponding to a grayscale level of an inputted video signal by section. The controller 40 may set up one section for sections having similar detected luminance levels.

Further, the controller 40 checks a permitted luminance level. The permitted luminance level denotes a luminance level that can be outputted on the display part 30 at a maximum. For example, a permitted luminance level that a medical display apparatus can output may be approximately 900 cd/m². However, the permitted luminance level is limited to 800 cd/m² for safety of a medical system That is, if the display apparatus according to an exemplary embodiment of the invention includes a medical display apparatus, the permitted luminance level would be approximately 800 cd/m².

On the other hand, the controller 40 converts a maximum luminance level of the respective luminance levels detected by section, that is, a luminance level corresponding to a maximum grayscale level, i.e., 255, into the permitted luminance level. In particular, the controller 40 first converts respective maximum luminance levels outputted by section, into a minimum level of the respective maximum outputted luminance levels. Then, the controller 40 converts the respective converted minimum level thereof, into the permitted luminance level again.

For example, suppose that the display part 30 is divided into a first section, a second section, and a third section, and respective maximum luminance levels outputted from the first, second, and third sections are 900 cd/m², 930 cd/m², and 920 cd/m², respectively. Then, the controller 40 converts the respective maximum luminance levels outputted by section, i.e., 900 cd/m², 930 cd/m² and 920 cd/m into a minimum level thereof, i.e. 900 cd/m². Then, the controller 40 converts the respective converted minimum levels thereof, i.e., 900 cd/m², 900 cd/m² and 900 cd/m², into the permitted luminance level, i.e., 800 cd/m² again.

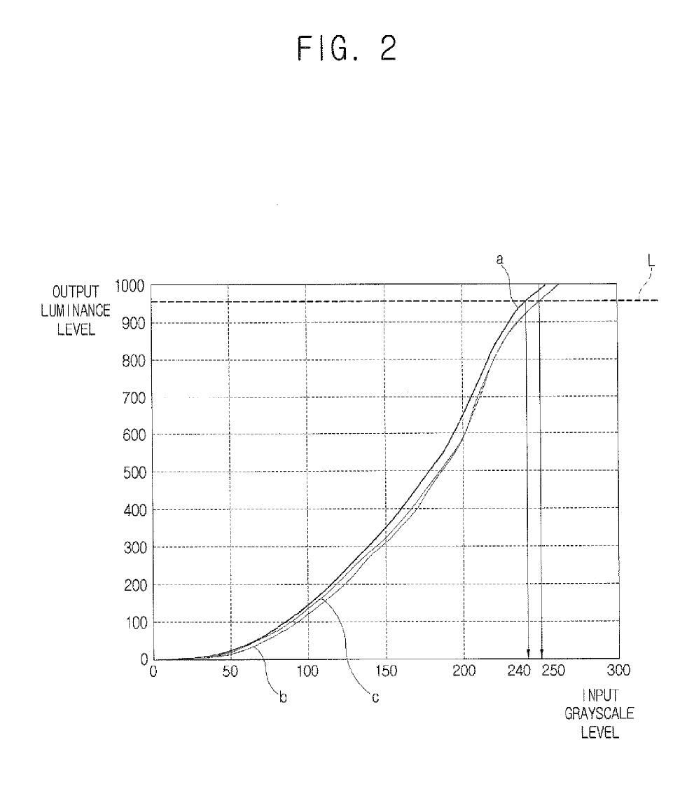

Hereinafter, an operation to convert the respective maximum outputted luminance levels into the permitted luminance level will be in detail described with reference to FIG. 2. FIG. 2 is a diagram illustrating an outputted luminance level detected by section in the display apparatus according to an exemplary embodiment of the present invention.

As illustrated, suppose that respective outputted luminance levels detected in the first, second, and third sections are a, b, and c, respectively, and the permitted luminance level is L. At this time, the permitted luminance level L may be the minimum level of the outputted luminance levels a, b, and c detected by section. For example, the permitted luminance level L may be a maximum luminance level of outputted luminance level detected in the third section c, i.e., approximately 950 cd/m when an input grayscale level is 250, as shown in FIG. 2.

If the input grayscale level is 250, since a first maximum luminance level of the outputted luminance level detected in the first section a is 970 cd/m², and a second maximum luminance level of the outputted luminance level detected in the second section b is 950 cd/m², the first maximum luminance level, 970 cd/m² and the second maximum luminance level, 950 cd/m² are converted into the permitted luminance level L. i.e., a maximum luminance level in the third section c, 950 cd/m².

The controller 40 converts the respective maximum outputted luminance levels into the permitted luminance level by calculating a calibration coefficient or by controlling a backlight unit (not shown) emitting a light to the display part 30. The calibration coefficient is calculated by dividing a grayscale level corresponding to the respective maximum luminance levels outputted by section, with another grayscale level corresponding to the minimum level of the respective maximum luminance levels outputted by section. For example, a first calibration coefficient of the first section is 250/240=1.04. A second calibration coefficient of the second section is 250/250=1.00. A third calibration coefficient of the third section is 1.00 because the maximum luminance level outputted in the third section is identical to the permitted luminance level.

The controller 40 converts the respective maximum outputted luminance levels into the permitted luminance level by multiplying a grayscale level of an input video signal corresponding to a concerned section by a corresponding calculated calibration coefficient. For example, since the first calibration coefficient is 1.04, the controller 40 multiplies a grayscale level of an input video signal corresponding to the first section by 1.04. Also, since the second and third calibration coefficients are 1.00, the controller 40 multiplies a grayscale level of an input video signal corresponding to the second section and the third section, respectively, by 1.00.

Further, the controller 40 compares the respective luminance levels with a reference luminance level. Here, the reference luminance level includes the DICOM curve, for example.

The controller 40 sets up a calibration table to calibrate a luminance level according to a grayscale level of the inputted video signal, based on a comparison of the respective luminance levels with the reference luminance level, which is the DICOM curve.

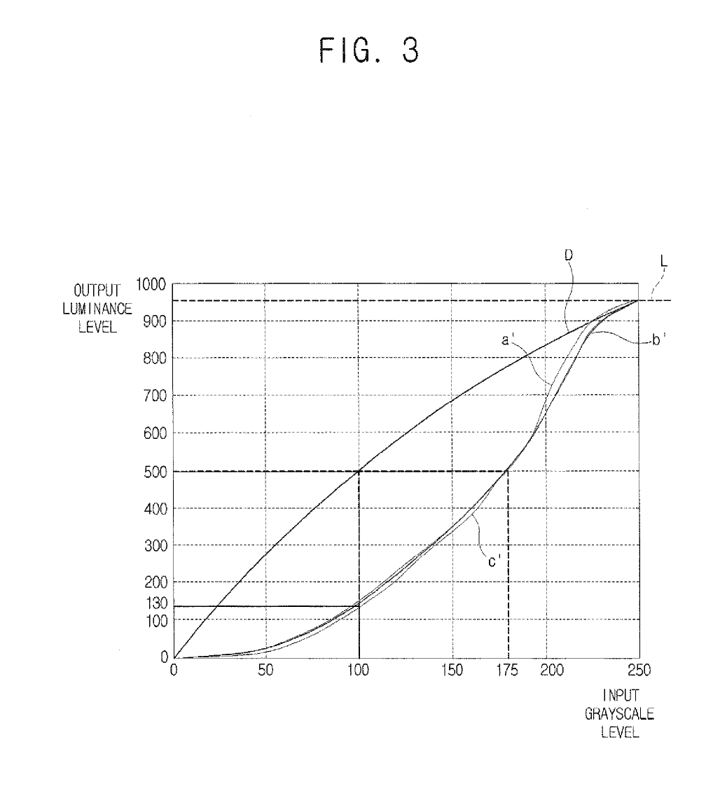

Hereinafter, an operation to set up the calibration table will be described with reference to FIG. 3. FIG. 3 is a diagram illustrating a converted luminance level and a reference luminance level by section in the display apparatus according to an exemplary embodiment of the present invention.

As illustrated, the controller 40 compares converted luminance levels a′, b′, and c′ of the first, second, and third sections, respectively, with the DICOM curve D. For example, in the case that a grayscale level inputted in the first section is 100, since a corresponding luminance level is appropriately 130 cd/m², and the corresponding reference luminance level is 500 cd/m², the controller 40 sets up the calibration table of the first section to calibrate the grayscale level from about 100 to about 175. Here, 175 is the grayscale level of the converted luminance level a′ of the first section, corresponding to the reference luminance level, i.e., 500 cd/m².

The controller 40 may store the respective calibration tables set up by section in a memory. The memory may be predetermined.

If a synchronizing signal is also inputted along with a video signal, the controller 40 determines in which section the video signal is displayed based on the inputted synchronizing signal. Then, the controller 40 controls the signal processing part 20 to calibrate a grayscale level of the inputted video signal based on the calibration table corresponding to the determined section. That is, the controller 40 calibrates a luminance level of the inputted video signal displayed by section to the DICOM curve.

Returning to the example described above, if a grayscale level inputted to the first section is 100, the controller controls the signal processing part 20 to calibrate the grayscale level from 100 to 175 based on the set calibration table, to thereby convert a luminance level corresponding to 100, i.e., 130 cd/m² into another luminance level corresponding to the calibrated grayscale level of 175, i.e., 500 cd/m².

On the other hand, the controller 40 may recalibrate the luminance level of the inputted video signal displayed by section so that a difference between luminance levels, corresponding to a section and its neighbor section, respectively, cannot be larger than a threshold range (for example, 5 percent). The threshold range may be predetermined. At this time, the controller 40 may recalibrate the luminance level thereof by using a linear smooth function.

That is, the controller 40 increases respective outputted luminance levels to control the respective maximum luminance levels outputted by section to be the permitted luminance level, thereby to generate no loss of a corresponding contrast ratio. Further, since the controller 40 sets up respective calibration tables divided by section, the respective maximum outputted luminance levels can satisfy the DICOM curve by section.

In addition, the controller 40 recalibrates the respective luminance levels of the inputted video signal displayed by section to prevent a difference between the respective luminance levels calibrated by section from being larger than a threshold range. The threshold range may be predetermined. Accordingly, the whole luminance levels can be uniformly outputted.

Hereinafter, another exemplary embodiment of the present invention will be described with reference to FIG. 1. It should be noted that, if there are common elements in exemplary embodiments, the same reference numbers will be used. Thus, duplicated description will be partially omitted as necessary.

As illustrated in FIG. 1, a display apparatus according to another exemplary embodiment includes a similar configuration as the above-described exemplary embodiment of the present invention, but may further include a user selecting part 35.

The user selecting part 35 includes a key, etc. to select or release a luminance calibrating function to get respective luminance levels outputted by section to be uniform. The user selecting part 35 further includes a key signal generating part (not shown) to generate a key signal corresponding to manipulation of a menu key provided on a remote controller or a corresponding case. The user selecting part 35 may be provided as a shortcut to select or release the luminance calibrating function in a side of the display apparatus.

If the luminance calibrating function is selected from the user selecting part 35, the controller 40 converts the respective luminance levels into a permitted luminance level, and sets up a calibration coefficient based on the respective converted luminance levels to calibrate a corresponding video signal.

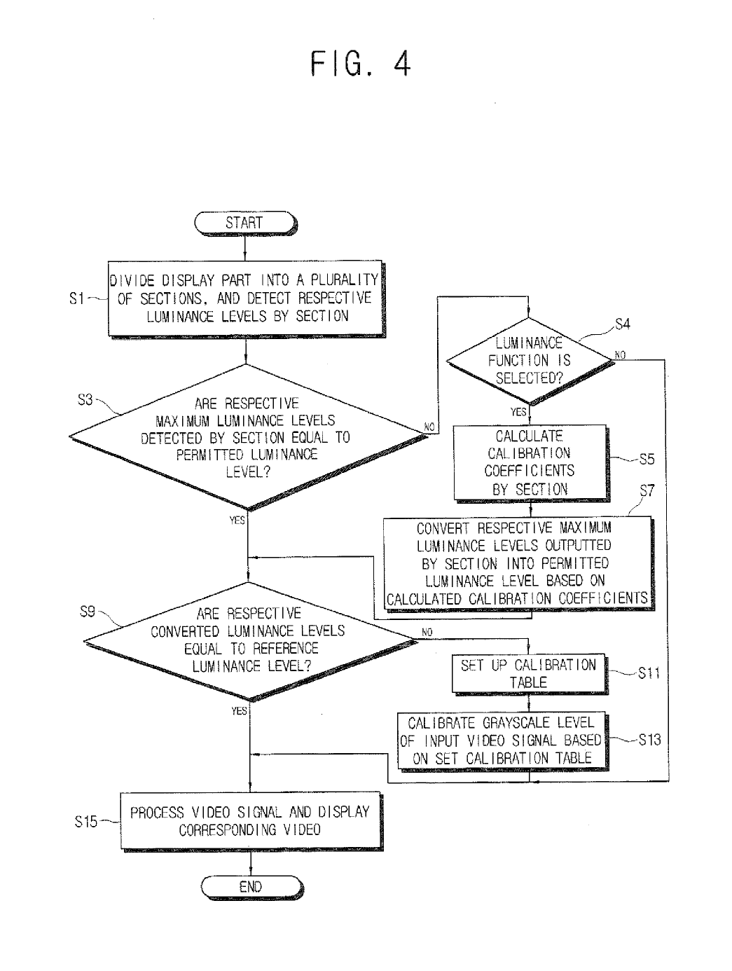

Hereinafter, a control method of display apparatus according to exemplary embodiments of the present invention will be described with reference to FIG. 4. It is for example described that the user selecting part 35 can select or release a luminance calibrating function.

As shown in FIG. 4, the display part 30 is divided into a plurality of sections, and respective luminance levels are detected by section (operation S1).

Whether respective maximum luminance levels of the outputted luminance levels detected by section are equal to a permitted luminance level capable of being outputted on the display part 30 is determined (operation S3).

As the result of determining in operation S3, if the respective maximum outputted luminance levels are not equal to the permitted luminance level, whether the luminance calibrating function is selected through the user selecting part 35 is checked (operation S4).

As the result of determining in operation S4, if the luminance calibrating function is not selected, a video signal is processed without a calibration process and a corresponding video is displayed on the display part 30 (operation S15).

As the result of determining in operation S4, if the luminance calibrating function is selected, a calibration coefficient is calculated by section to convert the respective maximum luminance levels into the permitted luminance level (operation S5).

The respective maximum luminance levels outputted by section are converted into the permitted luminance level based on the calculated calibration coefficient (operation S7).

Whether the respective converted luminance levels are equal to a reference luminance level (for example, the DICOM curve) is checked (operation S9).

As the result of determining in operation S9, if the respective converted luminance levels are equal to the reference luminance level, the respective converted luminance levels satisfy the reference luminance level. Accordingly, the video signal is processed and the corresponding video is displayed (operation S15).

As the result of determining in operation S9, if the respective converted luminance levels are not equal to the reference luminance level, a calibration table is set up to get the respective converted luminance levels to be equal to the reference luminance level (operation S11).

The signal processing part 20 is controlled to calibrate a grayscale level of an input video signal based on the set calibration table (operation S13).

The video signal having the calibrated grayscale level is processed and the corresponding video is displayed (operation S15)

As described above, the controller 40 may recalibrate the inputted video signal displayed in operation S15 so that a difference between the respective luminance levels outputted by section is not larger than a threshold range. The threshold range may be predetermined.

That is, the controller 40 increases respective outputted luminance levels to control the respective maximum luminance levels outputted by section to be equal to the permitted luminance level, thereby to generate no loss of a corresponding contrast ratio. Further, the respective converted permitted luminance levels can controlled to satisfy the DICOM curve by section by setting up respective calibration tables by section.

In addition, the controller 40 recalibrates the luminance level of the inputted video signal displayed by section to prevent a difference between the luminance levels calibrated by section from being larger than a threshold range. The threshold range may be predetermined. Accordingly, the whole luminance levels can be uniformly outputted.

As apparent from the above description, according to exemplary embodiments of the present invention, there are provided a display apparatus and a control method thereof, which can control respective luminance levels outputted by section to satisfy the DICOM curve by setting up a calibration table by section.

Further, there are also provided a display apparatus and a control method thereof, which can generate no loss of a corresponding contrast ratio by increasing respective outputted luminance levels to control the respective maximum luminance levels outputted by section to be equal to the permitted luminance level.

In addition, there are also provided a display apparatus and a control method thereof, which can uniformly output the whole luminance levels by recalibrating the luminance level of the inputted video signal displayed by section to prevent a difference between the luminance levels calibrated by section from being larger than a threshold range.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A control method for displaying a video, the control method comprising:
dividing a display part into a plurality of sections;
detecting a plurality of output luminance levels which correspond to grayscale levels of an input video signal on a section by section basis;
converting the output luminance levels by calculating a plurality of calibration coefficients on a section by section basis and applying the calculated calibration coefficients to the respective detected output luminance levels to control respective maximum luminance levels of the detected output luminance levels to be a permitted luminance level; and
setting up a calibration table based on a comparison of the respective converted luminance levels with a reference luminance level.

2. The control method according to claim 1, wherein the permitted luminance level is a luminance level capable of being output on the display part at a maximum.

3. The control method according to claim 1, further comprising calibrating a grayscale level of the input video signal to output the respective output luminance levels of the input video signal based on the set calibration table.

4. The control method according to claim 1, wherein the detecting the output luminance levels on a section by section basis comprises combining at least two sections of the plurality of sections of the display part that have a difference in detected luminance levels between each other that is within a threshold range.

5. The control method according to claim 3, further comprising recalibrating the output luminance levels on a section by section basis to prevent a difference between output luminance levels corresponding to a section and a section neighboring the section, respectively, from being larger than a threshold range.

6. A display apparatus comprising:
a display part which comprises a plurality of sections;
a signal processing part which processes a received video signal; and
a controller which detects a plurality of output luminance levels corresponding to a grayscale level of the received video signal on a section by section basis, converts the output luminance levels by calculating calibration coefficients on a section by section basis and applying the calculated calibration coefficients to the respective detected output luminance levels to control respective maximum luminance levels of the detected output luminance levels to be a permitted luminance level, and sets up a calibration table by comparing the respective converted luminance levels with a reference luminance level.

7. The display apparatus according to claim 6, wherein the permitted luminance level is a luminance level capable of being displayed on the display part at a maximum.

8. The display apparatus according to claim 6, wherein the controller controls the signal processing part to output the output luminance levels of the video signal based on the set calibration table.

9. The display apparatus according to claim 8, wherein the controller controls the signal processing part to calibrate a grayscale level of the video signal.

10. The display apparatus according to claim 6, wherein the controller combines at least two sections of the plurality of sections of the display part that have a difference in detected output luminance levels between each other that is within a threshold range.

11. The display apparatus according to claim 9, wherein the controller recalibrates the output luminance levels on a section by section basis to prevent a difference between output luminance levels corresponding to a section and a section neighboring the section, respectively, from being larger than a threshold range.

12. The display apparatus according to claim 6, wherein the display apparatus is a medical display apparatus.
